(19) United States
(12) Patent Application Publication
(10) Pub. No.: US 2026/0081367 A1
(43) Pub. Date: Mar. 19, 2026

(54) CHIP-TYPE CONTACT ELEMENT AND CONNECTOR USING CHIP-TYPE CONTACT ELEMENT

(71) Applicant: JONHON OPTRONIC TECHNOLOGY CO., LTD., Luoyang (CN)

(72) Inventors: Gailin GU, Luoyang (CN); Jundong ZHANG, Luoyang (CN); Liusheng LI, Luoyang (CN); Jianqiang HAN, Luoyang (CN); Hui GUO, Luoyang (CN); Hao LI, Luoyang (CN); Jinchang ZHOU, Luoyang (CN); Jinyuan ZHANG, Luoyang (CN); Yan HE, Luoyang (CN)

(21) Appl. No.: 19/107,816

(22) PCT Filed: Feb. 13, 2023
(86) PCT No.: PCT/CN2023/075596

§ 371 Date: Feb. 28, 2025

(30) Foreign Application Priority Data
Aug. 29, 2022 (CN) 202222275908.6

(51) Int. Cl. H01R 4/48

(52) U.S. Cl. CPC H01R 4/489

(57) ABSTRACT

The present application provides a chip-type contact element, including: an outer shell, a first contact assembly and a second contact assembly, where the first contact assembly is arranged in the outer shell, a plurality of first spring claws are arranged oppositely at front and rear ends of the first contact assembly, the second contact assembly is arranged outside the first contact assembly and located in the outer shell, second spring claws arranged between two adjacent first spring claws are arranged at front and rear ends of the second contact assembly, and a plurality of third spring claws in contact with the second spring claws are arranged oppositely at front and rear ends of the shell. The present application has the advantages of simple processing process, low cost and high assembling and production efficiencies. In addition, the present application further discloses a connector including the chip-type contact element.

### TECHNICAL FIELD

The utility model relates to the technical field of connectors, and in particular to a chip-type contact element and a connector using the chip-type contact element.

### BACKGROUND

In the electrical connector industry, a contact element has always been the most important part on the connector, which is directly related to the reliability of the connection performance of the connector. Most of contact elements used at present are circular contact elements, and the circular contact elements have a complex processing process, high production cost and limited current-carrying capacity, so the requirements of the market on high-current connectors cannot be met increasingly. Furthermore, under the same flow capacity, a chip-type contact element is smaller than a circular contact element connector, so the chip-type contact element connector can better meet the market requirements of high performance and low cost.

Most of the commonly used chip-type contact elements are of a steel clad copper structure. That is, a conductive sheet is first processed into a multi-contact reed structure, then the conductive sheet is placed in an external supporting element, and the external supporting element wraps the conductive sheet to be integrally fixed and formed through the subsequent processing. An existing steel clad copper contact element has a complex processing and forming process, and only an adaptive connector with a single structure can be adapted after the external supporting element wraps the conductive sheet to be integrally fixed and formed through the subsequent processing, so that the production efficiency and cost of the chip-type contact element are affected.

### SUMMARY

In view of the problems in the prior art, the utility model provides a chip-type contact element and a connector using the chip-type contact element, with the advantages of simple processing process, low cost and high assembling and production efficiencies.

To solve the above technical problems, the utility model adopts the following technical solution: a chip-type contact element includes:
an outer shell;
a first contact assembly, arranged in the outer shell, a plurality of first spring claws arranged at intervals in a width direction of the outer shell being oppositely arranged at front and rear ends of the first contact assembly, and the first spring claws being used to be in conductive contact with an adaptive contact element; and
a second contact assembly, arranged outside the first contact assembly and located in the outer shell, second spring claws arranged between two adjacent first spring claws being arranged at front and rear ends of the second contact assembly, the second spring claws being used to be in conductive contact with the adaptive contact element, and a plurality of third spring claws in contact with the first spring claws or the second spring claws being oppositely arranged at front and rear ends of the outer shell and used to enhance a contact force between the first spring claws or the second spring claws and the adaptive contact element.

Further, the outer shell has a split symmetrical structure, and the outer shell includes two symmetrically spliced shells.

Further, the first contact assembly has a split symmetrical structure, and the first contact assembly includes two symmetrically spliced first contact elements.

Further, two sides of the first contact elements are bent into contact portions, and the two first contact elements abut against each other through end planes of two contact portions.

Further, the second contact assembly has a split symmetrical structure, the second contact assembly includes two symmetrically spliced second contact elements, and the two second contact elements are symmetrically arranged on upper and lower surfaces of the first contact assembly.

Further, a first clamping portion is arranged on the first contact elements, and a second clamping portion matched with the first clamping portion is arranged on the second contact elements.

Further, the first clamping portion is a groove or protrusion, and the second clamping portion is a protrusion or groove matched with the first clamping portion.

Further, a third clamping portion is arranged on the first contact elements, and a fourth clamping portion matched with the third clamping portion is arranged on the second contact elements.

Further, the third clamping portion is a groove or protrusion, and the fourth clamping portion is a protrusion or groove matched with the third clamping portion.

Further, a fifth clamping portion matched with the second clamping portion is arranged on the shells.

Further, the fifth clamping portion is a groove or protrusion matched with the second clamping portion.

Further, the outer shell is made of a steel material, and the first contact assembly and the second contact assembly are made of a copper material.

A connector includes an insulating shell and the chip-type contact element, where the chip-type contact element is mounted in the insulating shell.

As a preferred solution of the connector, a protrusion or groove matched with the fifth clamping portion is arranged in the insulating shell.

The present application has the following beneficial effects:

1. Compared with other contact elements, the chip-type contact element provided by the present application can achieve the docking of two ends and the adaptive contact element, and a new adaptive contact element can be added according to different end connection modes without adding new processing cost.

2. The shells, the first contact element and the second contact element are assembled into an assembly, and then are integrally formed through fixing processing, thereby achieving the advantages of simple processing process, low cost and high assembling and production efficiencies.

3. The third spring claws for enhancing the contact forces between the first spring claws or the second spring claws and the adaptive contact element are arranged at the front and rear ends of the outer shell, so that a plugging and unplugging force during plugging and unplugging with the adaptive contact element is enhanced, and the connection stability can be ensured even if in a vibration environment.

### BRIEF DESCRIPTION OF DRAWINGS

FIG. 1 is a structural schematic diagram of Embodiment 1 according to the utility model;

FIG. 2 is a structural schematic diagram of a first contact assembly of Embodiment 1 according to the utility model;

FIG. 3 is a partial exploded view of FIG. 1;

FIG. 4 is a structural schematic diagram of Embodiment 2 according to the utility model;

FIG. 5 is an exploded view of an outer shell in FIG. 4;

FIG. 6 is a structural schematic diagram of insertion matching of Embodiment 2 according to the utility model and a straight pin; and

FIG. 7 is a structural schematic diagram of insertion matching of Embodiment 2 according to the utility model and a bending pin.

Reference numerals in the drawings: 1. outer shell; 11. shell; 111. third spring claw; 112. fifth clamping portion; 2. second contact assembly; 21. second contact element; 211. second spring claw; 212. fourth clamping portion; 213. second clamping portion; 3. first contact assembly; 31. first contact element; 311. first spring claw; 312. first clamping portion; 313. third clamping portion.

### DETAILED DESCRIPTION OF THE EMBODIMENTS

To make the objectives, technical solutions and advantages of the utility model clearer, the utility model is described below in detail with reference to the accompanying drawings and embodiments. It should be understood that in the description of the utility model, unless otherwise specified, “a plurality of” means two or more; the orientation or position relationship indicated by terms “upper”, “lower”, “left”, “right”, “inner”, “outer”, “front end”, “rear end”, “head”, “tail” and the like are the orientation or position relationship as shown in the drawings, and these terms are only intended to facilitate description of the utility model and simplify the description, but not to indicate or imply that the mentioned devices or elements must have a specific orientation and must be established and operated in a specific orientation, and thus, these terms cannot be understood as a limitation to the utility model. Moreover, terms like “first”, “second”, “third” and the like are only used for description, and cannot be understood as indicating or implying relative importance.

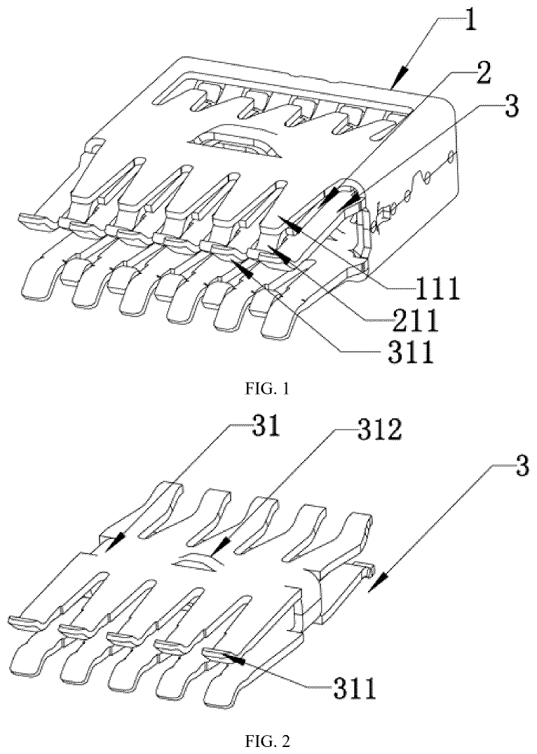

Referring to FIG. 1 to FIG. 3, Embodiment 1 of the utility model provides a chip-type contact element, including: an outer shell 1, a first contact assembly 3 and a second contact assembly 2, where the first contact element 3 is arranged in the outer shell 1, a plurality of first spring claws 311 arranged at intervals in a width direction of the outer shell 1 are oppositely arranged at front and rear ends of the first contact assembly 3, the first spring claws 311 are used to be in conductive contact with an adaptive contact element, the second contact assembly 2 is arranged outside the first contact assembly 3 and located in the outer shell 1, second spring claws 211 arranged between two adjacent first spring claw 311 are arranged at front and rear ends of the second contact assembly 2, the second sprig claws 211 are used to be in conductive contact with the adaptive contact element, a plurality of third sprig claws 111 in contact with the second spring claws 211 are oppositely arranged at front and rear ends of the outer shell 1 and are used to enhance a contact force between the second spring claws 211 and the adaptive contact element, and the adaptive contact element is a chip-type pin.

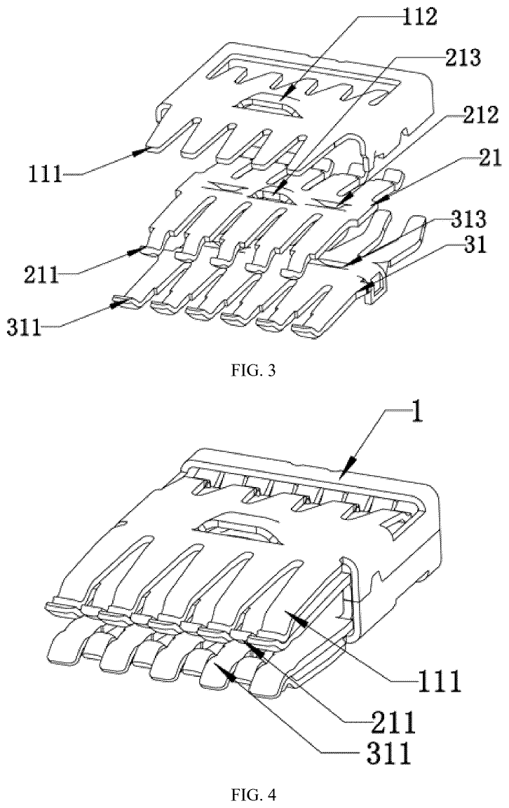

As shown in FIG. 2 and FIG. 3, the outer shell 1 is of a hollow structure, openings are arranged at the front and rear ends of the outer shell 1, the outer shell 1 has a split symmetrical structure, the outer shell 1 includes two symmetrically spliced shells 11, the first contact assembly 3 has a split symmetrical structure, the first contact assembly 3 includes two symmetrically spliced first contact elements 31, the first spring claws 311 at the front and rear end of the first contact elements 31 are arranged symmetrically, so that processing is facilitated and the processing efficiency is improved, thereby improving the mounting efficiency; the number of the first spring claws 311 on the first contact elements 31 is 12 or 10, two sides of each of the first contact elements 31 are bent into contact portions, the two first contact elements 31 abut against each other through end planes of two contact portions, the second contact assembly 2 has a split symmetrical structure, the second contact assembly 2 includes two symmetrically spliced second contact elements 21, the two second contact elements 21 are symmetrically arranged on upper and lower surfaces of the first contact assembly 3, and the second spring claws 211 at the front and rear ends of the second contact elements 21 are arranged symmetrically, so that processing is facilitated and the processing efficiency is improved, thereby improving the mounting efficiency; the number of the second spring claws 211 on the second contact elements 21 is 10, so there are 22 points of a single side of the chip-type contact element of the present application in contact with the chip-type pin, thereby further ensuring the stability of connection with the chip-type pin and also ensuring the connection stability in a vibration environment; and the shells 11, the first contact elements 31 and the second contact elements 21 are all formed through mold stamping and bending, and are assembled into assemblies to be integrally formed through fixing processing, thereby achieving the advantages of simple processing process, low cost and high assembling and production efficiencies.

Further, points of the first spring claws 311 in contact with the chip-type pin are first contact points, points of the second spring claws 211 in contact with the chip-type pin are second contact points, and the first contact points and the second contact points are staggered in length directions of the shells 11.

Specifically, a first clamping portion 312 is arranged on the first contact elements 31, a second clamping portion 213 matched with the first clamping portion 312 is arranged on the second contact elements 21, the first clamping portion 312 is a groove or protrusion, the second clamping portion 213 is a protrusion or groove matched with the first clamping portion 312, a third clamping portion 313 is arranged on the first contact elements 31, a fourth clamping portion 212 matched with the third clamping portion 313 is arranged on the second contact elements 21, a fifth clamping portion 112 matched with the second clamping portion 213 is arranged on the shells 11, the third clamping portion 313 is a groove or protrusion, the fourth clamping portion 212 is a protrusion or groove matched with the third clamping portion 313, and the fifth clamping portion 112 is a groove or protrusion matched with the second clamping portion 213.

The stability of the first contact elements 31, the second contact elements 21 and the shells 11 during spliced connection is ensured by providing the first clamping portion 312, the second clamping portion 213, the third clamping portion 313, the fourth clamping portion 212 and the fifth clamping portion 112, thereby ensuring the limitation of the first contact elements, the second contact elements and the shells in an up-and-down direction, improving the connection stability and ensuring the connection stability in the vibration environment.

In addition, the outer shell 1 is made of a steel material, and the first contact assembly 3 and the second contact assembly 2 are made of a copper material. Preferably, the first contact assembly 3 and the second contact assembly 2 are made of a red copper material, thereby reducing the product cost and enhancing the conductivity of the chip-type contact element of the present application.

Of course, the utility model mode is not limited to the above embodiments, and several other embodiments based on the design concept of the utility model are further provided below.

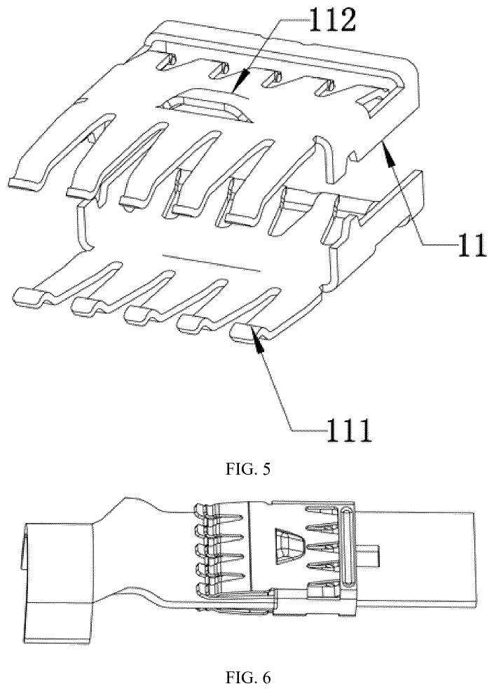

For example, Embodiment 2 is different from the above embodiments in that: as shown in FIG. 4 and FIG. 5, a plurality of third spring claws 111 in contact with the first spring claws 311 are oppositely arranged at the front and rear ends of the outer shell 1 and are used to enhance a contact force between the first spring claws 311 and the adaptive contact element, and the adaptive contact element is a chip-type pin.

The third spring claws 111 for enhancing the contact forces between the first spring claws 311 or the second spring claws 211 and the adaptive contact element are oppositely arranged at the front and rear ends of the outer shell 1, so that a plugging and unplugging force during plugging and unplugging with the chip-type pin is enhanced, and the connection stability can be ensured even if in a vibration environment.

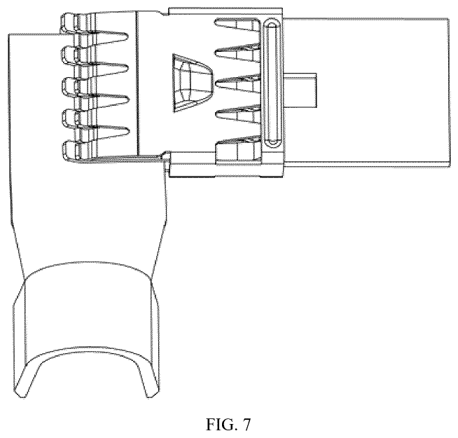

The chip-type contact element can be matched with a straight pin or a bending pin and applicable to a straight or bending connector. As shown in FIG. 8, straight chip-type pins are inserted into the front and rear ends of the chip-type contact element. As shown in FIG. 7, a bending chip-type pin is inserted into the front end of the chip-type contact element, and a bending chip-type pin is inserted into the rear end of the chip-type contact element. Compared with other contact elements, the contact element can achieve the docking of two ends and the chip-type pins, and a new adaptive contact element can be added according to different end connection modes without adding new processing cost.

The present application provides a specific embodiment of a connector: in this embodiment, a connector includes an insulating shell and a chip-type contact element provided by any of the above chip-type contact element embodiments, where the chip-type contact element is mounted in the insulating shell, a protrusion or groove matched with the fifth clamping portion 112 is arranged in the insulating shell, and the insulating shell is matched with the fifth clamping portion 112, thereby limiting the chip-type contact element and ensuring the connection stability.

It should be noted that the above embodiments are only used to describe the utility model, but the utility model is not limited to the above embodiments. Any simple modifications, equivalent changes and embellishments made on the above embodiments according to the technical essence of the utility model shall fall within the protection scope of the utility model.

1. A chip-type contact element, comprising:
an outer shell;
a first contact assembly, arranged in the outer shell, a plurality of first spring claws arranged at intervals in a width direction of the outer shell being oppositely arranged at front and rear ends of the first contact assembly, and the first spring claws being used to be in conductive contact with an adaptive contact element; and
a second contact assembly, arranged outside the first contact assembly and located in the outer shell, second spring claws arranged between two adjacent first spring claws (311) being arranged at front and rear ends of the second contact assembly, the second spring claws being used to be in conductive contact with the adaptive contact element, and a plurality of third spring claws in contact with the first spring claws or the second spring claws being oppositely arranged at front and rear ends of the outer shell and used to enhance a contact force between the first spring claws or the second spring claws and the adaptive contact element.

2. The chip-type contact element according to claim 1, wherein the outer shell has a split symmetrical structure, and the outer shell comprises two symmetrically spliced shells.

3. The chip-type contact element according to claim 2, wherein the first contact assembly has a split symmetrical structure, and the first contact assembly comprises two symmetrically spliced first contact elements.

4. The chip-type contact element according to claim 3, wherein two sides of the first contact elements are bent into contact portions, and the two first contact elements abut against each other through end planes of two contact portions.

5. The chip-type contact element according to claim 3, wherein the second contact assembly has a split symmetrical structure, the second contact assembly comprises two symmetrically spliced second contact elements, and the two second contact elements are symmetrically arranged on upper and lower surfaces of the first contact assembly.

6. The chip-type contact element according to claim 5, wherein a first clamping portion is arranged on the first contact elements, and a second clamping portion matched with the first clamping portion is arranged on the second contact elements.

7. The chip-type contact element according to claim 6, wherein the first clamping portion is a groove or protrusion, and the second clamping portion is a protrusion or groove matched with the first clamping portion.

8. The chip-type contact element according to claim 7, wherein a third clamping portion is arranged on the first contact elements, and a fourth clamping portion matched with the third clamping portion is arranged on the second contact elements.

9. The chip-type contact element according to claim 8, wherein the third clamping portion is a groove or protrusion, and the fourth clamping portion is a protrusion or groove matched with the third clamping portion.

10. The chip-type contact element according to claim 7, wherein a fifth clamping portion matched with the second clamping portion is arranged on the shells.

11. The chip-type contact element according to claim 10, wherein the fifth clamping portion is a groove or protrusion matched with the second clamping portion.

12. The chip-type contact element according to claim 1, wherein the outer shell is made of a steel material, and the first contact assembly and the second contact assembly are made of a copper material.

13. A connector, comprising an insulating shell and the chip-type contact element according to claim 11, wherein the chip-type contact element is mounted in the insulating shell.

14. The connector according to claim 13, wherein a protrusion or groove matched with the fifth clamping portion is arranged in the insulating shell.
